(19) United States
(12) Patent Application Publication
(10) Pub. No.: US 2025/0377982 A1
(43) Pub. Date: Dec. 11, 2025

(54) METHOD, DEVICE AND APPARATUS OF BACKING UP DATA, AND NONVOLATILE COMPUTER-READABLE STORAGE MEDIUM

(71) Applicant: SUZHOU METABRAIN INTELLIGENT TECHNOLOGY CO., LTD., Suzhou, Jiangsu (CN)

(72) Inventor: Bingtao WU, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 18/878,628

(22) PCT Filed: Mar. 30, 2023
(86) PCT No.: PCT/CN2023/085267

§ 371 Date: Dec. 23, 2024

(30) Foreign Application Priority Data
Nov. 17, 2022 (CN) 202211437858.5

(51) Int. Cl. G06F 11/14

(52) U.S. Cl. CPC G06F 11/1458; G06F 2201/805

(57) ABSTRACT

The present application discloses a method of backing up data, including the following steps: acquiring load information of each of secondary end controllers, respectively; allocating, according to the load information of each of the secondary end controllers, each of secondary end logical subvolumes obtained by pre-division to corresponding one of the secondary end controllers, to obtain secondary end subvolume configuration information; synchronizing the secondary end subvolume configuration information to a primary end, to enable the primary end transmit, according to the secondary end subvolume configuration information, each piece of data to be backed up to corresponding one of the secondary end controllers; and processing, by each of the secondary end controllers, respectively received data to be backed up, to complete data backup at a secondary end.

### CROSS-REFERENCE TO RELATED APPLICATION

This application is a National Stage Application of International Application No. PCT/CN2023/085267 filed on Mar. 30, 2023, which claims the benefit of Ser. No. 20/221,1437858.5 filed on Nov. 17, 2022 in China, and which applications are incorporated herein by reference. To the extent appropropriate, a claim of priority is made to each of the above disclosed applications.

### TECHNICAL FIELD

Embodiments of the present application relate to technical field of data backup, and in particular to a method, a device and an apparatus of backing up data and a nonvolatile computer-readable storage medium (or referred to as nonvolatile readable storage medium).

### BACKGROUND

With the explosive growth of information data, the requirements for performance in various scenarios are becoming increasingly stringent. In order to improve the reliability of data, the data is usually backed up, and a common method of backing up data is to remotely back up data in main storage to remote storage.

In remote replication, when a primary end transmits data to a secondary end, the following two solutions of selecting secondary end controllers are mostly adopted: one is that a primary end controller transmits data to a fixed controller at the secondary end when transmitting the data; the other is that the primary end controller transmits data to each controller at the secondary end in a balanced manner when transmitting the data. The above two solutions have a common defect: the primary end cannot perceive the status of idle resources of each controller at the secondary end, resulting in that even if the transmitted data is balanced among the controllers at the secondary end (namely, secondary end controllers), the idle resources of the secondary end controllers are different, and the resources of the secondary end cannot be fully utilized when the same amount of data is processed.

In summary, how to effectively solve a problem, such as that the resources of the secondary end cannot be fully utilized in a case where each of the secondary end controllers processes the same amount of data and the idle resources of the secondary end controllers are different in an existing method of backing up data, is an urgent problem that those skilled in the art need to solve.

### SUMMARY

An objective of an embodiment of the present application is to provide a method of backing up data, the method optimizes a selection strategy for secondary end controllers in remote replication, so that the resources of the secondary end can be fully utilized, thereby improving data transmission performance. Another objective of an embodiment of the present application is to provide a device and an apparatus of backing up data and a nonvolatile computer-readable storage medium (namely, nonvolatile readable storage medium).

In order to solve the described technical problems, the embodiments of the present application provide the following technical solution:

A method of backing up data, includes:
acquiring load information of each of secondary end controllers, respectively;
allocating, according to the load information of each of the secondary end controllers, each of secondary end logical subvolumes obtained by pre-division to corresponding one of the secondary end controllers, to obtain secondary end subvolume configuration information;
synchronizing the secondary end subvolume configuration information to a primary end, to enable the primary end transmit, according to the secondary end subvolume configuration information, each piece of data to be backed up to corresponding one of the secondary end controllers; and
processing, by each of the secondary end controllers, respectively received data to be backed up, to complete data backup at a secondary end.

In an optional implementation of the embodiment of the present application, the allocating, according to the load information of each of the secondary end controllers, each of secondary end logical subvolumes obtained by pre-division to corresponding one of the secondary end controllers, to obtain secondary end subvolume configuration information includes:
allocating, according to the load information of each of the secondary end controllers, each of the secondary end logical subvolumes obtained by pre-division to corresponding one of the secondary end controllers, to obtain an allocation result;
generating, according to the allocation result, IO paths corresponding to each of the secondary end controllers respectively;
acquiring identification information of each of the secondary end controllers, respectively; and
generating the secondary end subvolume configuration information according to each of the IO paths and the identification information of each of the secondary end controllers.

In an optional implementation of the embodiment of the present application, before the acquiring load information of each of the secondary end controllers, respectively, the method further includes:
acquiring a quantity of the secondary end controllers;
performing subvolume division on a secondary volume according to the quantity of the secondary end controllers, to obtain each of the secondary end logical subvolumes; and
allocating each of the secondary end logical subvolumes to corresponding one of the secondary end controllers to obtain initial subvolume ownership information, and synchronizing the initial subvolume ownership information to the primary end; and
the allocating, according to the load information of each of the secondary end controllers, each of the secondary end logical subvolumes obtained by pre-division to corresponding one of the secondary end controllers includes:
judging, according to the load information of each of the secondary end controllers, whether to adjust the initial subvolume ownership information; and
in a case where it is judged, according to the load information of each of the secondary end controllers, to adjust the initial subvolume ownership information, adjusting the initial subvolume ownership information according to the load information of each of the secondary end controllers.

In an optional implementation of the embodiment of the present application, the judging, according to the load information of each of the secondary end controllers, whether to adjust the initial subvolume ownership information includes:
acquiring, according to the load information of each of the secondary end controllers, a load difference value between a secondary end controller with a maximum current load and a secondary end controller with a minimum current load; and
judging whether the load difference value exceeds a preset threshold.

In an optional implementation of the embodiment of the present application, after adjusting the initial subvolume ownership information according to the load information of each of the secondary end controllers, the method further includes:
recording first subvolume identification information of an adjusted secondary end logical subvolume, first secondary volume identification information of a secondary volume to which the adjusted secondary end logical subvolume belong, and first secondary end controller identification information of a secondary end controller to which the adjusted secondary end logical subvolume belong; and
generating the secondary end subvolume configuration information according to the first subvolume identification information, the first secondary volume identification information and the first secondary end controller identification information.

In an optional implementation of the embodiment of the present application, the performing subvolume division on a secondary volume according to the quantity of the secondary end controllers includes:
acquiring a preset secondary end logical subvolume size; and
performing subvolume division on the secondary volume according to the secondary end logical subvolume size; and
the allocating each of the secondary end logical subvolumes to corresponding one of the secondary end controllers includes:
sequentially numbering each of the secondary end logical subvolumes starting from 1, to obtain a number of each of the secondary end logical subvolumes subvolume numbers;
obtaining a remainder when the number of each of the secondary end logical subvolumes is divided by the quantity of the secondary end controllers, as a remainder result corresponding to the number of each of the secondary end logical subvolumes; and
allocating each of the secondary end logical subvolumes to corresponding one of the secondary end controllers according to the remainder result corresponding to the number of each of the secondary end logical subvolumes.

In an optional implementation of the embodiment of the present application, after the synchronizing the initial subvolume ownership information to the primary end, the method further includes:
receiving a subvolume hotspot data statistical result sent by the primary end;
judging, according to the subvolume hotspot data statistical result, whether to adjust the initial subvolume ownership information;
in a case where it is judged, according to the subvolume hotspot data statistical result, to adjust the initial subvolume ownership information, adjusting the initial subvolume ownership information according to the subvolume hotspot data statistical result, to obtain target subvolume ownership information; and
synchronizing the target subvolume ownership information to the primary end.

In an optional implementation of the embodiment of the present application, the adjusting the initial subvolume ownership information according to the subvolume hotspot data statistical result includes:
allocating each of hotspot logical subvolumes to corresponding one of the secondary end controllers in a balanced manner according to the subvolume hotspot data statistical result.

In an optional implementation of the embodiment of the present application, wherein the adjusting the initial subvolume ownership information according to the subvolume hotspot data statistical result includes:
recording and obtaining second subvolume identification information of an adjusted secondary end logical subvolume, second secondary volume identification information of a secondary volume to which the adjusted secondary end logical subvolume belong, and second secondary end controller identification information of a secondary end controller to which the adjusted secondary end logical subvolume belong; and
generating the target subvolume ownership information according to the second subvolume identification information, the second secondary volume identification information and the second secondary end controller identification information.

In an optional implementation of the embodiment of the present application, the receiving a subvolume hotspot data statistical result sent by each of the primary end includes:
receiving the subvolume hotspot data statistical result sent by the primary end and obtained by performing, according to a data block granularity, hotspot data statistic on primary end logical subvolumes.

In an optional implementation of the embodiment of the present application, transmitting, by the primary end according to the secondary end subvolume configuration information, each piece of data to be backed up to corresponding one of the secondary end controllers includes:
transmitting, by the primary end according to the secondary end subvolume configuration information, each piece of the data to be backed up to the corresponding one of the secondary end controllers according to a grain granularity via an IO path corresponding to the corresponding one of the secondary end controllers respectively.

In an optional implementation of the embodiment of the present application, the transmitting, by the primary end according to the secondary end subvolume configuration information, each piece of the data to be backed up to the corresponding one of the secondary end controllers according to a grain granularity via an IO path corresponding to the corresponding one of the secondary end controllers respectively includes:
transmitting, by the primary end according to the secondary end subvolume configuration information, each piece of the data to be backed up to the corresponding one of the secondary end controllers according to the grain granularity by using a service-time strategy via an IO path corresponding to the corresponding one of the secondary end controllers respectively.

In an optional implementation of the embodiment of the present application, the secondary end subvolume configuration information includes a correspondence between each of the secondary end logical subvolumes and each of the secondary end controllers.

In an optional implementation of the embodiment of the present application, before to the acquiring a preset secondary end logical subvolume size, the method further includes: presetting a division granularity for performing subvolume division on a logical volume, wherein the division granularity is configured to represent a size of the secondary end logical subvolumes.

In an optional implementation of the embodiment of the present application, the processing, by each of the secondary end controllers, respectively received data to be backed up, to complete data backup at a secondary end includes: performing, by each of the secondary end controllers, a reading and writing operation on one or more secondary end logical subvolumes corresponding to each of the secondary end controllers, to complete data backup at the secondary end.

In an optional implementation of the embodiment of the present application, a three-dimensional data type constructed by the second subvolume identification information, the second secondary volume identification information and the second secondary end controller identification information does not record all logical subvolume information, only records logical subvolume information that needs to be adjusted, and records a node identifier as a group identifier of a group of IO paths, wherein the node identifier is an identifier of a secondary end controller to which an adjusted secondary end logical subvolume of which the logical subvolume information needs to be adjusted belongs, the group of IO paths exist between the primary end and the secondary end controller to which the adjusted secondary end logical subvolume of which the logical subvolume information needs to be adjusted belongs.

In an optional implementation of the embodiment of the present application, after the generating the target subvolume ownership information according to the second subvolume identification information, the second secondary volume identification information and the second secondary end controller identification information, the method further includes: finding, by the primary end when transmitting the data to be backed up, a secondary end controller identifier as the second secondary end controller identification information in the three-dimensional data type according to a logical volume identifier as the second secondary volume identification information and a logical subvolume identifier as the second subvolume identification information, if the secondary end controller identifier is found, sending the data to a group of IO paths corresponding to a secondary end controller identified by the secondary end controller identifier for transmission, and if the secondary end controller identifier is not found, transmitting the data according to the initial subvolume ownership information.

A device of backing up data, includes:
a load information acquiring module, configured to acquire load information of each of secondary end controllers, respectively;
a subvolume allocating module, configured to allocate, according to the load information of each of the secondary end controllers, each of secondary end logical subvolumes obtained by pre-division to corresponding one of the secondary end controllers, to obtain secondary end subvolume configuration information;
a configuration information synchronizing module, configured to synchronize the secondary end subvolume configuration information to a primary end, to enable the primary end transmit, according to the secondary end subvolume configuration information, each piece of data to be backed up to corresponding one of the secondary end controllers; and
a data backup module, configured to process, by each of the secondary end controllers, respectively received data to be backed up, to complete data backup at a secondary end.

An apparatus of backing up data, includes:
a memory, configured to store a computer program; and
a central processing unit, configured to, when executing the computer program, implement steps of the method of backing up data as mentioned above.

A nonvolatile computer-readable storage medium (or referred to as nonvolatile readable storage medium), stores a computer program, wherein when the computer program is executed by a central processing unit, steps of the method of backing up data as mentioned above are implemented.

A method of backing up data provided by the embodiment of the present application includes: acquiring load information of each of secondary end controllers, respectively; allocating, according to the load information of each of the secondary end controllers, each of secondary end logical subvolumes obtained by pre-division to corresponding one of the secondary end controllers, to obtain secondary end subvolume configuration information; synchronizing the secondary end subvolume configuration information to a primary end, to enable the primary end transmit, according to the secondary end subvolume configuration information, each piece of data to be backed up to corresponding one of the secondary end controllers; and processing, by each of the secondary end controllers, respectively received data to be backed up, to complete data backup at a secondary end.

It can be seen from the above technical solution that a secondary end logical volume is pre-divided into a plurality of secondary end logical subvolumes, load information of each of secondary end controllers is acquired, each of the secondary end logical subvolumes obtained by pre-division is allocated to corresponding one of the secondary end controllers according to the load information of each of secondary end controllers, generated secondary end subvolume configuration information is synchronized to a primary end, and the primary end transmit, according to the secondary end subvolume configuration information, each piece of data to be backed up to corresponding one of the secondary end controllers. Respectively received data to be backed up is processed by each of the secondary end controllers, and data backup is completed at a secondary end. By allocating the secondary end logical subvolumes according to the load information of each of the secondary end controllers, the load balance is achieved among the secondary end controllers as much as possible, and a selection strategy for the secondary end controllers in remote replication is optimized, so that the secondary end resources are fully utilized, thereby improving data transmission performance.

Accordingly, the embodiments of the present application further provide a device and an apparatus of backing up data corresponding to the method of backing up data mentioned above, and a nonvolatile computer-readable storage medium (or referred to as nonvolatile readable storage medium), which have the above technical effects and are not described herein again.

### BRIEF DESCRIPTION OF THE DRAWINGS

In order to explain the technical solutions in the embodiments of the present application or the prior art more clearly, drawings that need to be used in the description of the embodiments or the prior art will be briefly introduced below. Obviously, the drawings described below are only some embodiments of the present application. For those of ordinary skill in the art, other drawings can also be obtained based on these drawings without paying any creative labor.

FIG. 1 is an implementation flowchart of a method of backing up data in an embodiment of the present application;

FIG. 2 is another implementation flowchart of the method of backing up data in an embodiment of the present application;

FIG. 3 is a schematic diagram of logical subvolume ownership division in an embodiment of the present application;

FIG. 4 is a schematic diagram of another logical subvolume ownership division in an embodiment of the present application;

FIG. 5 is a structural block diagram of a device of backing up data in an embodiment of the present application;

FIG. 6 is a schematic diagram of an apparatus of backing up data provided by an embodiment of the present application; and

FIG. 7 is an optional schematic structural diagram of an apparatus of backing up data provided by an embodiment of the present application.

### DETAILED DESCRIPTION OF THE EMBODIMENTS

To make those skilled in the art better understand the solutions of the embodiments of the present application, the embodiments of the present application are described in detail below in conjunction with the drawings and optional implementations. Obviously, the embodiments described are only a part of embodiments of the present application, and are not all of embodiments thereof. Based on the embodiments of the present application, all other embodiments obtained by those of ordinary skill in the art without paying any creative labor shall fall within the scope of the protection of the embodiments of the present application.

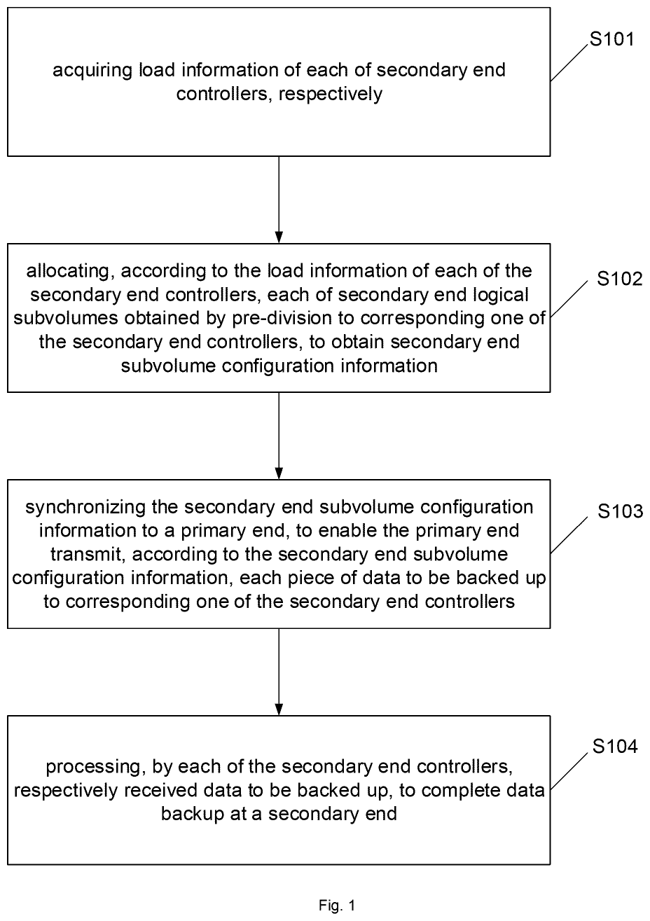

Referring to FIG. 1, FIG. 1 is an implementation flowchart of a method of backing up data in an embodiment of the present application. The method may include the following steps:
S101: acquiring load information of each of secondary end controllers, respectively.

Besides backing up primary end data, the secondary end controllers may have other service loads that need to be processed, such as a production service load. When the primary end data needs to be backed up to a secondary end, the load information of each of the secondary end controllers is acquired respectively.
S102: allocating, according to the load information of each of the secondary end controllers, each of secondary end logical subvolumes obtained by pre-division to corresponding one of the secondary end controllers, to obtain secondary end subvolume configuration information.

A secondary volume of the secondary end is pre-divided into a plurality of secondary end logical subvolumes (SunLun), e.g., a secondary volume is divided into a plurality of secondary end logical subvolumes with the same size. After the load information of each of the secondary end controllers is acquired respectively, each of the secondary end logical subvolumes obtained by pre-division is allocated to corresponding one of the secondary end controllers according to the load information of each of the secondary end controllers, e.g., when loads of the secondary end controllers are different, a relatively large quantity of secondary end logical subvolumes are allocated to one or more secondary end controllers with a relatively small load, and a relatively small quantity of secondary end logical subvolumes are allocated to one or more secondary end controllers with a relatively large load, so as to obtain secondary end subvolume configuration information. The secondary end subvolume configuration information includes a correspondence between each of the secondary end logical subvolumes and each of the secondary end controllers.

In an optional implementation of the embodiment of the present application, Step S102 may include the following steps:
Step 1: allocating, according to the load information of each of the secondary end controllers, each of the secondary end logical subvolumes obtained by pre-division to corresponding one of the secondary end controllers, to obtain an allocation result;
Step 2: generating, according to the allocation result, IO paths corresponding to each of the secondary end controllers respectively;
Step 3: acquiring identification information of each of the secondary end controllers, respectively; and
Step 4: generating the secondary end subvolume configuration information according to each of the IO paths and the identification information of each of the secondary end controllers.

For ease of description, the above four steps may be combined for description.

Primary end logical subvolumes of a primary end have a one-to-one correspondence with secondary end logical subvolumes of a secondary end, each of the primary end logical subvolumes is controlled by corresponding one of primary end controllers, respectively, and a communication connection is established between each of the primary end controllers and corresponding one of the secondary end controllers. After each of the secondary end logical subvolumes obtained by pre-division is allocated to corresponding one of the secondary end controllers according to the load information of each of the secondary end controllers, to obtain an allocation result, IO (Input/Output) paths corresponding to each of the secondary end controllers respectively are generated according to the allocation result, e.g., a primary end logical subvolume with serial number 1 is controlled by a primary end controller 1, and a secondary end logical subvolume with serial number 1 is controlled by a secondary end controller 2, so that an IO path between the primary end controller 1 and the secondary end controller 2 is generated. Identification information of each of the secondary end controllers is acquired respectively, and the secondary end subvolume configuration information is generated according to the IO paths and the identification information of each of the secondary end controllers.

For example, a private protocol instruction corresponding to a target port group may be made, the private protocol instruction (OPCODE) is made, and the private protocol instruction includes an ID (identity document) of a controller and an IO path in the controller. When a partner relationship between the primary end and the secondary end is established for the first time and the IO path of the secondary end changes, the secondary end actively reports the ID of the controller and IO path information to the primary end via the private protocol instruction, so as to reduce as far as possible performance loss caused by information interaction between the primary end and the secondary end.
S103: synchronizing the secondary end subvolume configuration information to a primary end, to enable the primary end transmit, according to the secondary end subvolume configuration information, each piece of data to be backed up to corresponding one of the secondary end controllers.

After each of the secondary end logical subvolumes obtained by pre-division is allocated to corresponding one of the secondary end controllers according to the load information of each of the secondary end controllers, to obtain the secondary end subvolume configuration information, the secondary end subvolume configuration information is synchronized to a primary end, to enable the primary end transmit, according to the secondary end subvolume configuration information, each piece of data to be backed up to corresponding one of the secondary end controllers. Following the foregoing example, the primary end transmits the data to be backed up to the secondary end controller 2 via the primary end controller 1.
S104: processing, by each of the secondary end controllers, respectively received data to be backed up, to complete data backup at a secondary end.

After the primary end transmits, according to the secondary end subvolume configuration information, each piece of the data to be backed up to corresponding one of the secondary end controllers, respectively received data to be backed up is processed by the corresponding one of the secondary end controllers, so that data backup is completed at a secondary end. Following the foregoing example, after the secondary end controller 2 receives the data to be backed up sent by the primary end controller 1, corresponding reading and writing operations are performed on the secondary end logical subvolume with serial number 1, so that data backup is completed at the secondary end. The embodiment of the present application specifies a controller for processing each piece of data to be backed up, avoiding locking caused by operating the same PBA (Physical Block Address) by a plurality of controllers of the secondary end (namely, a plurality of the secondary end controllers), and optimizing transmission performance. The data to be backed up is directly transmitted to a correct secondary end controller, reducing the forwarding of the data to be backed up between the secondary end controllers, shortening an IO stack path, and increasing the flushing speed of the data to be backed up.

It can be seen from the above technical solution that a secondary end logical volume is pre-divided into a plurality of secondary end logical subvolumes, load information of each of the secondary end controllers is acquired, each of the secondary end logical subvolumes obtained by pre-division is allocated to corresponding one of the secondary end controllers according to the load information of each of the secondary end controllers, generated secondary end subvolume configuration information is synchronized to a primary end, and the primary end transmits, according to the secondary end subvolume configuration information, each piece of data to be backed up to corresponding one of the secondary end controllers. Respectively received data to be backed up is processed by the corresponding one of the secondary end controllers, and data backup is completed at a secondary end. By allocating the secondary end logical subvolumes according to the load information of the secondary end controllers, the load balance is achieved among the secondary end controllers as much as possible, and a selection strategy for the secondary end controllers in remote replication is optimized, so that the secondary end resources are fully utilized, thereby improving data transmission performance.

It needs be noted that based on the above embodiment, the embodiments of the present application further provide corresponding improvement solutions. In the subsequent embodiments, the same steps as or corresponding steps in the foregoing embodiments may be referred to each other, and corresponding beneficial effects may also be referred to each other, which are not described in detail in the following improved embodiments.

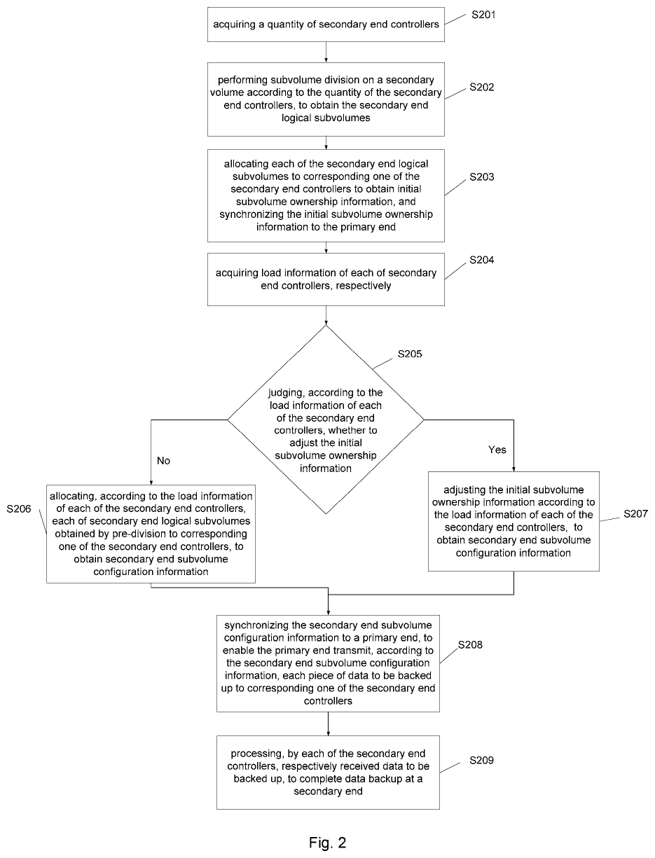

Referring to FIG. 2, FIG. 2 is another implementation flowchart of the method of backing up data in an embodiment of the present application. The method may include the following steps:
S201: acquiring a quantity of secondary end controllers;

A secondary end generally includes a plurality of secondary end controllers, and when primary end data needs to be backed up to the secondary end, the quantity of the secondary end controllers is acquired.
S202: performing subvolume division on a secondary volume according to the quantity of the secondary end controllers, to obtain secondary end logical subvolumes.

After the quantity of the secondary end controllers is acquired, subvolume division is performed on a secondary volume according to the quantity of the secondary end controllers, to obtain secondary end logical subvolumes. For example, a secondary volume may be divided as far as possible into secondary end logical subvolumes with a quantity being an integral multiple of the quantity of the secondary end controllers, so as to ensure as far as possible that an equal quantity of secondary end logical subvolumes are allocated to each of the secondary end controllers.
S203: allocating each of the secondary end logical subvolumes to corresponding one of the secondary end controllers to obtain initial subvolume ownership information, and synchronizing the initial subvolume ownership information to a primary end.

After the subvolume division is performed on a secondary volume according to the quantity of the secondary end controllers, to obtain the secondary end logical subvolumes, each of the secondary end logical subvolumes is allocated to corresponding one of the secondary end controllers, for example, the allocation may be performed according to a principle of allocating an equal quantity of the secondary end logical subvolumes to each of the secondary end controllers as much as possible, to obtain initial subvolume ownership information, and the initial subvolume ownership information is synchronized to a primary end, so that the primary end obtains a correspondence between each of the secondary end logical subvolumes and each of the secondary end controllers. By actively performing secondary end logical subvolume division at the secondary end according to the load information of each of the secondary end controllers, the secondary end actively reports a controller path selection to the primary end, the controller path selection is provided by the secondary end via a subvolume ownership, and the active right is in the secondary end, which is beneficial to balanced utilization of secondary end resources, so that the secondary end resources are fully utilized, thereby improving data transmission performance.

The configuration information of the primary end and the secondary end is fixed in a design stage, and subsequent synchronization is not required, thereby reducing performance loss caused by information interaction between the primary end and the secondary end.

In an optional implementation of the embodiment of the present application, the performing subvolume division on a secondary volume according to the quantity of the secondary end controllers may include the following steps:
Step 1: acquiring a preset secondary end logical subvolume size; and
Step 2: performing subvolume division on the secondary volume according to the secondary end logical subvolume size;

Correspondingly, the allocating each of the secondary end logical subvolumes to corresponding one of the secondary end controllers may include the following steps:
Step 1: sequentially numbering each of the secondary end logical subvolumes starting from 1, to obtain a number of each of the secondary end logical subvolumes;
Step 2: obtaining a remainder when the number of each of the secondary end logical subvolumes is divided by the quantity of the secondary end controllers, as a remainder result corresponding to the number of each of the secondary end logical subvolumes; and
Step 3: allocating each of the secondary end logical subvolumes to corresponding one of the secondary end controllers according to the remainder result corresponding to the number of each of the secondary end logical subvolumes.

For ease of description, the above several steps may be combined for description.

A division granularity for performing subvolume division on a logical volume is preset, e.g., it may be set that a logical volume is divided into logical subvolumes with a granularity of 128 M. When the subvolume division is performed on a secondary volume, a preset secondary end logical subvolume size is acquired, the subvolume division is performed on the secondary volume according to the secondary end logical subvolume size, the secondary end logical subvolumes are sequentially numbered starting from 1, to obtain a number of each of the secondary end logical subvolumes; a remainder when the number of each of the secondary end logical subvolumes is divided by the quantity of the secondary end controllers is obtained, as a remainder result corresponding to the number of each of the secondary end logical subvolumes, and each of the secondary end logical subvolumes are allocated to corresponding one of the secondary end controllers according to the remainder result corresponding to the number of each of the secondary end logical subvolumes. By sequentially numbering the secondary end logical subvolumes starting from 1, and allocating each of the secondary end logical subvolumes to corresponding one of the secondary end controllers by means of obtaining a remainder when the number of each of the secondary end logical subvolumes is divided by the quantity of the secondary end controllers, it is achieved that the secondary end logical subvolumes are allocated to the secondary end controllers in a balanced manner.

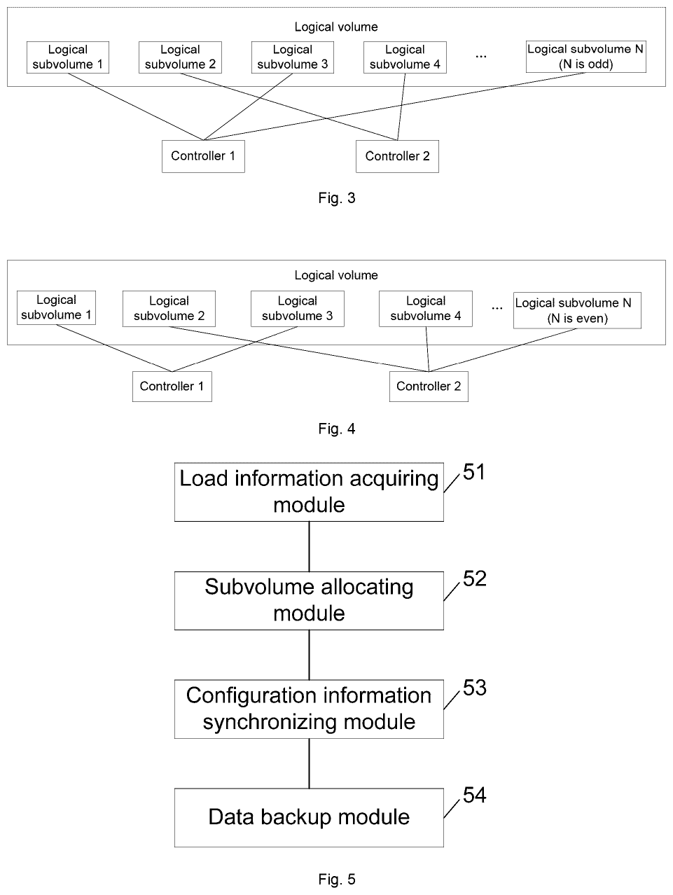

Referring to FIG. 3 and FIG. 4, FIG. 3 is a schematic diagram of logical subvolume ownership division in an embodiment of the present application, and FIG. 4 is a schematic diagram of another logical subvolume ownership division in an embodiment of the present application. Taking two controllers as an example, assuming that the number of a logical subvolume is N, when N % 2=1, the logical subvolume is allocated to controller 1, and when N % 2=0, the logical subvolume is allocated to controller 2.

In an optional implementation of the embodiment of the present application, after the synchronizing the initial subvolume ownership information to the primary end, the method may further include the following steps:

Step 1: receiving a subvolume hotspot data statistical result sent by the primary end;

Step 2: judging, according to the subvolume hotspot data statistical result, whether to adjust the initial subvolume ownership information; in a case where it is judged, according to the subvolume hotspot data statistical result, to adjust the initial subvolume ownership information, performing Step 3, and in a case where it is judged, according to the subvolume hotspot data statistical result, to not adjust the initial subvolume ownership information, performing no processing;

Step 3: adjusting the initial subvolume ownership information according to the subvolume hotspot data statistical result, to obtain target subvolume ownership information; and

Step 4: synchronizing the target subvolume ownership information to the primary end.

For ease of description, the above four steps may be combined for description.

Data in one or more subvolumes is read and written relatively frequently, a lot of hotspot data exists in these subvolumes, and little hotspot data exists in other subvolumes, resulting in unbalanced utilization of controller resources at the secondary end. Based on the foregoing situation, the primary end counts subvolume hotspot information, i.e., counts the quantity of times of reading and writing data of each subvolume, and sends the counted subvolume hotspot information to the secondary end. The secondary end receives a subvolume hotspot data statistical result sent by the primary end, it is judged, according to the subvolume hotspot data statistical result, whether to adjust the initial subvolume ownership information; in a case where it is judged, according to the subvolume hotspot data statistical result, to adjust the initial subvolume ownership information, it is indicated that distribution of hotspot subvolumes (namely, each of the hotspot subvolumes is a subvolume in which the hotspot data exists) in the secondary end controllers is not balanced, the initial subvolume ownership information is adjusted according to the subvolume hotspot data statistical result, to obtain target subvolume ownership information; and in a case where it is judged, according to the subvolume hotspot data statistical result, to not adjust the initial subvolume ownership information, it is indicated that distribution of hotspot subvolumes in the secondary end controllers is relatively balanced, and no processing is performed. By performing statistic on subvolume hotspot data, and adjusting the secondary end logical subvolume ownership according to the subvolume hotspot data statistical result, the occurrence probability of a phenomenon of unbalanced utilization of the secondary end resources is reduced, so that the secondary end resources are fully utilized, thereby improving data transmission performance.

In an optional implementation of the embodiment of the present application, the adjusting the initial subvolume ownership information according to the subvolume hotspot data statistical result may include the following steps:
allocating each of hotspot logical subvolumes to corresponding one of the secondary end controllers in a balanced manner according to the subvolume hotspot data statistical result.

After it is determined according to the subvolume hotspot data statistical result that the initial subvolume ownership information needs to be adjusted, hotspot logical subvolumes are allocated to the secondary end controllers in a balanced manner according to the subvolume hotspot data statistical result. Thus, the load balance of the secondary end controllers is improved, fully utilizing the secondary end resources.

In an optional implementation of the embodiment of the present application, the receiving a subvolume hotspot data statistical result sent by the primary end may include the following steps:
receiving the subvolume hotspot data statistical result sent by the primary end and obtained by performing, according to a data block granularity, hotspot data statistic on each of primary end logical subvolumes.

When the primary end performs hotspot data statistic on primary end logical subvolumes, hotspot data statistic is performed on the primary end logical subvolumes according to a data block granularity, and the subvolume hotspot data statistical result is sent to the secondary end. The secondary end receives the subvolume hotspot data statistical result sent by the primary end and obtained by performing, according to a data block granularity, hotspot data statistic on the primary end logical subvolumes. By performing hotspot data statistic on the primary end logical subvolumes according to the data block granularity, the accuracy of the hotspot data statistical result is greatly improved.

In an optional implementation of the embodiment of the present application, wherein the adjusting the initial subvolume ownership information according to the subvolume hotspot data statistical result, may further include the following steps:
Step 1: recording second subvolume identification information of an adjusted secondary end logical subvolume, second secondary volume identification information of a secondary volume to which the adjusted secondary end logical subvolume belong, and second secondary end controller identification information of a secondary end controller to which the adjusted secondary end logical subvolume belong; and
Step 2: generating the target subvolume ownership information according to the second subvolume identification information, the second secondary volume identification information and the second secondary end controller identification information.

For ease of description, the above two steps may be combined for description.

After the initial subvolume ownership information is adjusted according to the subvolume hotspot data statistical result, second subvolume identification information of an adjusted secondary end logical subvolume, second secondary volume identification information of a secondary volume to which the adjusted secondary end logical subvolume belong, and second secondary end controller identification information of a secondary end controller to which the adjusted secondary end logical subvolume belong are recorded, and the target subvolume ownership information is generated according to the second subvolume identification information, the second secondary volume identification information and the second secondary end controller identification information. By generating the target subvolume ownership information according to the second subvolume identification information, the second secondary volume identification information and the second secondary end controller identification information, subsequently, the accurate positioning of an IO path may be achieved by directly finding the adjusted subvolume ownership information.

A three-dimensional data type constructed by the second subvolume identification information, the second secondary volume identification information and the second secondary end controller identification information does not record all logical subvolume information, only records logical subvolume information that needs to be adjusted, and a node identifier NodeID serves as a group identifier GroupID of a group of IO paths, wherein the node identifier NodeID is an identifier of a secondary end controller to which an adjusted secondary end logical subvolume of which the logical subvolume information needs to be adjusted belongs, the group of IO paths exist between the primary end and the secondary end controller to which the adjusted secondary end logical subvolume of which the logical subvolume information needs to be adjusted belongs, reducing the amount of data exchanged between the primary end and the secondary end. When transmitting the data to be backed up, the primary end finds a secondary end controller identifier as the second secondary end controller identification information preferentially in the three-dimensional data type according to a logical volume identifier LunID as the second secondary volume identification information and a logical subvolume identifier SubLunID as the second subvolume identification information. if the secondary end controller identifier is found, the data is sent to a group of IO paths corresponding to a secondary end controller identified by the secondary end controller identifier for transmission, and if the secondary end controller identifier is not found, the data is transmitted according to the initial subvolume ownership information.
S204: acquiring load information of each of secondary end controllers, respectively.
S205: judging, according to the load information of each of the secondary end controllers, whether to adjust the initial subvolume ownership information; in a case where it is judged, according to the load information of each of the secondary end controllers, to not adjust the initial subvolume ownership information, performing Step S206, and in a case where it is judged, according to the load information of each of the secondary end controllers, to adjust the initial subvolume ownership information, performing Step S207.

Load information of each of the secondary end controllers is acquired respectively, and it is judged, according to the load information of each of the secondary end controllers, whether to adjust the initial subvolume ownership information. For example, above judging operation may be performed according to a preset period. In a case where it is judged, according to the load information of each of the secondary end controllers, to not adjust the initial subvolume ownership information, it is indicated that the current loads of the secondary end controllers are relatively balanced, and Step S206 is performed, and in a case where it is judged, according to the load information of each of the secondary end controllers, to adjust the initial subvolume ownership information, it is indicated that the current loads of the secondary end controllers are greatly different, Step S207 is performed.

In an optional implementation of the embodiment of the present application, Step S205 may include the following steps:
Step 1: acquiring, according to the load information of each of the secondary end controllers, a load difference value between a secondary end controller with a maximum current load and a secondary end controller with a minimum current load; and
Step 2: judging whether the load difference value exceeds a preset threshold.

For ease of description, the above two steps may be combined for description.

When it is judged, according to the load information of each of the secondary end controllers, whether to adjust the initial subvolume ownership information, a load difference value between a secondary end controller with a maximum current load and a secondary end controller with a minimum current load is acquired according to the load information of each of the secondary end controllers, and it is judged whether the load difference value exceeds a preset threshold. By comparing the load difference value between the secondary end controllers with the preset threshold, it is determined, according to a comparison result, whether to adjust the initial subvolume ownership information, so that an effective basis is provided for adjusting the initial subvolume ownership information, and the load balance of the secondary end controllers can be ensured as far as possible on the basis of ensuring that frequent adjustments are not performed.

It needs be noted that the preset threshold may be set and adjusted according to an actual situation, which is not limited in the embodiments of the present application.

As shown in Table 1, Table 1 is an adjustment table for adjusting subvolume ownership information according to a load difference value between controllers.

TABLE 1

| Load difference | Number of | |
|---|---|---|
| value between | balanced logical | |
| controllers | subvolumes | Notes |
| <10% | 0 | Unbalanced |
| <20% | 10 | Adjusting 10 logical |
| | | subvolumes from one or more |
| | | controllers with a high load to |
| | | be owned to one or more |
| | | controllers with a low load |
| <30% | 20 | Adjusting 20 logical |
| | | subvolumes from one or more |
| | | controllers with a high load to |
| | | be owned to one or more |
| | | controllers with a low load |
| <30% | 50 | Adjusting 50 logical |
| | | subvolumes from one or more |
| | | controllers with a high load to |
| | | be owned to one or more |
| | | controllers with a low load |

It can be seen from Table 1 that the load difference values between the controllers are different, and the numbers of logical subvolumes that need to be balanced are also different, and the larger the load difference value is, the larger the number of logical subvolumes that need to be balanced is.
S206: allocating, according to the load information of each of the secondary end controllers, each of secondary end logical subvolumes obtained by pre-division to corresponding one of the secondary end controllers, to obtain secondary end subvolume configuration information.
S207: adjusting the initial subvolume ownership information according to the load information of each of the secondary end controllers, to obtain secondary end subvolume configuration information.

When it is determined, according to the load information of each of the secondary end controllers, that the initial subvolume ownership information needs to be adjusted, it is indicated that the current loads of the secondary end controllers are greatly different, the initial subvolume ownership information is adjusted according to the load information of each of the secondary end controllers to obtain the secondary end subvolume configuration information, so that the loads of the secondary end controllers are balanced.

In an optional implementation of the embodiment of the present application, after the adjusting the initial subvolume ownership information according to the load information, the method may further include the following steps:
Step 1: recording first subvolume identification information of an adjusted secondary end logical subvolume, first secondary volume identification information of a secondary volume to which the adjusted secondary end logical subvolume belong, and first secondary end controller identification information of a secondary end controller to which the adjusted secondary end logical subvolume belong; and
Step 2: generating the secondary end subvolume configuration information according to the first subvolume identification information, the first secondary volume identification information and the first secondary end controller identification information.

For ease of description, the above two steps may be combined for description.

After the initial subvolume ownership information is adjusted according to the load information of each of the secondary end controllers, the correspondence, obtained by initial allocation, between each of the secondary end logical subvolumes and corresponding one of the secondary end controllers will change, first subvolume identification information of an adjusted secondary end logical subvolume, first secondary volume identification information of a secondary volume to which the adjusted secondary end logical subvolume belong, and first secondary end controller identification information of a secondary end controller to which the adjusted secondary end logical subvolume belong are recorded, and the secondary end subvolume configuration information is generated according to the first subvolume identification information, the first secondary volume identification information and the first secondary end controller identification information. Thus, it is ensured that the secondary end subvolume configuration information corresponds to an actual allocation result.
S208: synchronizing the secondary end subvolume configuration information to a primary end, to enable the primary end transmit, according to the secondary end subvolume configuration information, each piece of data to be backed up to corresponding one of the secondary end controllers.

In an optional implementation of the embodiment of the present application, the transmitting, by the primary end according to the secondary end subvolume configuration information, each piece of data to be backed up to corresponding one of the secondary end controllers may include the following steps:
transmitting, by the primary end according to the secondary end subvolume configuration information, each piece of the data to be backed up to the corresponding one of the secondary end controllers according to a grain granularity via an IO path corresponding to the corresponding one of the secondary end controllers respectively.

The primary end transmits, according to the secondary end subvolume configuration information, each piece of the data to be backed up to the corresponding one of the secondary end controllers according to a grain granularity via an IO path corresponding to the corresponding one of the secondary end controllers respectively. By transmitting the data to be backed up according to a grain granularity smaller than the data block granularity, the accurate transmission of the backed up data is realized.

In an optional implementation of the embodiment of the present application, the transmitting, by the primary end according to the secondary end subvolume configuration information, each piece of the data to be backed up to the corresponding one of the secondary end controllers according to a grain granularity via an IO path corresponding to the corresponding one of the secondary end controllers respectively may include the following steps:
transmitting, by the primary end according to the secondary end subvolume configuration information, each piece of the data to be backed up to the corresponding one of the secondary end controllers according to the grain granularity by using a service-time strategy via an IO path corresponding to the corresponding one of the secondary end controllers respectively.

The primary end transmit, according to the secondary end subvolume configuration information, each piece of the data to be backed up to the corresponding one of the secondary end controllers according to the grain granularity by using a service-time strategy via an IO path corresponding to the corresponding one of the secondary end controllers respectively. By performing data transmission by using the service-time strategy, the balance of processing response time is achieved.
S209: processing, by each of the secondary end controllers, respectively received data to be backed up, to complete data backup at a secondary end.

Corresponding to the above method embodiment, an embodiment of the present application further provides a device of backing up data. The device of backing up data described below and the method of backing up data described above may be referred to each other correspondingly.

Referring to FIG. 5, FIG. 5 is a structural block diagram of a device of backing up data in an embodiment of the present application, and the device may include:
a load information acquiring module 51, configured to acquire load information of each of secondary end controllers, respectively;
a subvolume allocating module 52, configured to allocate, according to the load information of each of the secondary end controllers, each of secondary end logical subvolumes obtained by pre-division to corresponding one of the secondary end controllers, to obtain secondary end subvolume configuration information;
a configuration information synchronizing module 53, configured to synchronize the secondary end subvolume configuration information to a primary end, to enable the primary end transmit, according to the secondary end subvolume configuration information, each piece of data to be backed up to corresponding one of the secondary end controllers; and
a data backup module 54, configured to process, by each of the secondary end controllers, respectively received data to be backed up, to complete data backup at a secondary end.

It can be seen from the above technical solution that a secondary end logical volume is pre-divided into a plurality of secondary end logical subvolumes, load information of each of secondary end controllers is acquired, each of the secondary end logical subvolumes obtained by pre-division are allocated to corresponding one of the secondary end controllers according to the load information of each of the secondary end controllers, generated secondary end subvolume configuration information is synchronized to a primary end, and the primary end transmits, according to the secondary end subvolume configuration information, each piece of data to be backed up to corresponding one of the secondary end controllers. Respectively received data to be backed up is processed by each of the secondary end controllers, and data backup is completed at a secondary end. By allocating the secondary end logical subvolumes according to the load information of each of the secondary end controllers, the load balance among the secondary end controllers is achieved as much as possible, and a selection strategy for the secondary end controllers in remote replication is optimized, to enable the secondary end resources are fully utilized, thereby improving data transmission performance.

In an optional implementation of the embodiment of the present application, the subvolume allocating module 52 includes:
a subvolume allocating submodule, configured to allocate, according to the load information of each of the secondary end controllers, each of the secondary end logical subvolumes obtained by pre-division to corresponding one of the secondary end controllers, to obtain an allocation result;
a path generating submodule, configured to generate, according to the allocation result, IO paths corresponding to each of the secondary end controllers respectively;
an identification information acquiring submodule, configured to acquire identification information of each of the secondary end controllers, respectively; and
a configuration information generating submodule, configured to generate the secondary end subvolume configuration information according to each of the IO paths and the identification information of each of the secondary end controllers.

In an optional implementation of the embodiment of the present application, the device may further include:
a controller number acquiring module, configured to acquire a quantity of the secondary end controllers before the load information of each of the secondary end controllers is acquired respectively;
a subvolume division module, configured to perform subvolume division on a secondary volume according to the quantity of the secondary end controllers, to obtain the secondary end logical subvolumes; and
a first ownership information synchronizing module, configured to allocate each of the secondary end logical subvolumes to corresponding one of the secondary end controllers to obtain initial subvolume ownership information, and synchronize the initial subvolume ownership information to the primary end; and
the subvolume allocating module 52 includes:
a judgment submodule, configured to judge, according to the load information of each of the secondary end controllers, whether to adjust the initial subvolume ownership information; and
an ownership information adjustment submodule, configured to adjust the initial subvolume ownership information according to the load information of each of the secondary end controllers, in a case where it is determined, according to the load information of each of the secondary end controllers, that the initial subvolume ownership information needs to be adjusted.

In an optional implementation of the embodiment of the present application, the judgment submodule includes:
a load difference value acquiring unit, configured to acquire, according to the load information of each of the secondary end controllers, a load difference value between a secondary end controller with a maximum current load and a secondary end controller with a minimum current load; and
a judgment unit, configured to judge whether the load difference value exceeds a preset threshold.

In an optional implementation of the embodiment of the present application, the device may further include:
a first information recording module, configured to, after the initial subvolume ownership information is adjusted according to the load information of each of the secondary end controllers, record first subvolume identification information of an adjusted secondary end logical subvolume, first secondary volume identification information of a secondary volume to which the adjusted secondary end logical subvolume belong, and first secondary end controller identification information of a secondary end controller to which the adjusted secondary end logical subvolume belong; and
a configuration information generating module, configured to generate the secondary end subvolume configuration information according to the first subvolume identification information, the first secondary volume identification information and the first secondary end controller identification information.

In an optional implementation of the embodiment of the present application, the subvolume division module includes:
a subvolume size acquiring submodule, configured to acquire a preset secondary end logical subvolume size; and
a first subvolume division submodule, configured to perform subvolume division on the secondary volume according to the secondary end logical subvolume size; and
the first ownership information synchronizing module includes:
a subvolume numbering submodule, configured to sequentially number each of the secondary end logical subvolumes starting from 1, to obtain a number of each of the secondary end logical subvolumes;
a remainder result acquiring submodule, configured to obtain a remainder when the number of each of the secondary end logical subvolumes is divided by the quantity of the secondary end controllers, as a remainder result corresponding to the number of each of the secondary end logical subvolumes; and
a second subvolume allocation submodule, configured to allocate each of the secondary end logical subvolumes to corresponding one of the secondary end controllers according to the remainder result corresponding to the number of each of the secondary end logical subvolumes.

In an optional implementation of the embodiment of the present application, the device may further include:
a statistical result receiving module, configured to receive a subvolume hotspot data statistical result sent by the primary end after the initial subvolume ownership information is synchronized to the primary end;
a judgment module, configured to judge, according to the subvolume hotspot data statistical result, whether to adjust the initial subvolume ownership information;
an ownership information adjustment module, configured to, when it is determined according to the subvolume hotspot data statistical result that the initial subvolume ownership information needs to be adjusted, adjust the initial subvolume ownership information according to the subvolume hotspot data statistical result, to obtain target subvolume ownership information; and
a second ownership information synchronizing module, configured to synchronize the target subvolume ownership information to the primary end.

In an optional implementation of the embodiment of the present application, the ownership information adjustment module is optionally a module for allocating each of hotspot logical subvolumes to corresponding one of the secondary end controllers in a balanced manner according to the subvolume hotspot data statistical result.

In an optional implementation of the embodiment of the present application, wherein the second ownership information synchronizing module may further include:
a second information recording submodule, configured to, after the initial subvolume ownership information is adjusted according to the subvolume hotspot data statistical result, record second subvolume identification information of an adjusted secondary end logical subvolume, second secondary volume identification information of a secondary volume to which the adjusted secondary end logical subvolume belong, and second secondary end controller identification information of a secondary end controller to which the adjusted secondary end logical subvolume belong; and
an ownership information generating submodule, configured to generate the target subvolume ownership information according to the second subvolume identification information, the second secondary volume identification information and the second secondary end controller identification information.

In an optional implementation of the embodiment of the present application, the statistical result receiving module is optionally a module for receiving the subvolume hotspot data statistical result sent by the primary end and obtained by performing, according to a data block granularity, hotspot data statistic on each of primary end logical subvolumes.

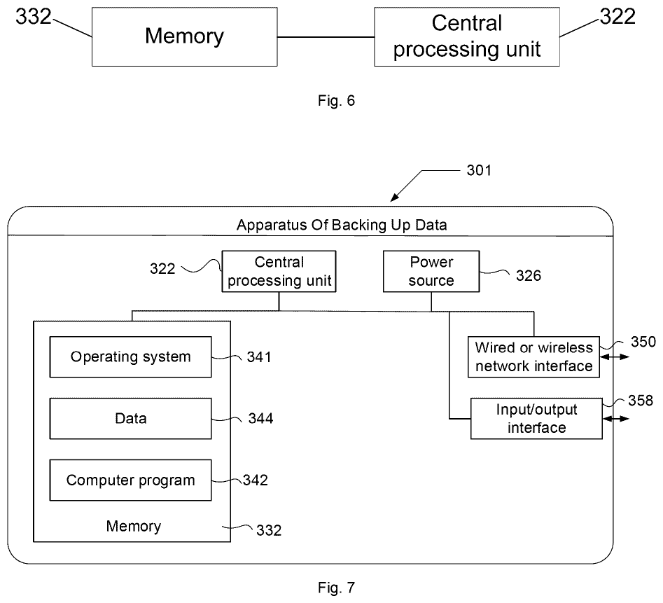

Corresponding to the above method embodiment, referring to FIG. 6, FIG. 6 is a schematic diagram of an apparatus of backing up data provided by an embodiment of the present application, and the apparatus may include:
a memory 332, configured to store a computer program; and
a central processing unit 322, configured to, when executing the computer program, implement steps of the method of backing up data according to the method embodiment mentioned above.

Optionally, referring to FIG. 7, FIG. 7 is an optional schematic structural diagram of an apparatus of backing up data provided by an embodiment of the present application, and there are significant differences among the apparatus of backing up data due to differences in configuration or performance, and the apparatus of backing up data may include a central processing unit (CPU) 322 (for example, one or more central processing units) and a memory 332, wherein the memory 332 stores one or more computer programs 342 or one or more pieces of data 344. The memory 332 may be temporary storage or persistent storage. The programs stored in the memory 332 may include one or more modules (not shown), and each module may include a series of instruction operations in the apparatus of backing up data. Optionally, the central processing units 322 may be configured to be in communication with the memory 332, and perform, on an apparatus 301 of backing up data, a series of instruction operations in the memory 332.

The apparatus 301 of backing up data may further include one or more power sources 326, one or more wired or wireless network interfaces 350, one or more input/output interfaces 358, and/or one or more operating systems 341.

The steps in the method of backing up data described above may be implemented by the structure of the apparatus of backing up data.

Corresponding to the above method embodiment, an embodiment of the present application further provides a nonvolatile computer-readable storage medium (or referred to as nonvolatile readable storage medium), storing a computer program, and when the computer program is executed by a central processing unit, the following steps may be implemented:
acquiring load information of each of secondary end controllers, respectively; allocating, according to the load information of each of the secondary end controllers, each of secondary end logical subvolumes obtained by pre-division to corresponding one of the secondary end controllers, to obtain secondary end subvolume configuration information; synchronizing the secondary end subvolume configuration information to a primary end, to enable the primary end transmit, according to the secondary end subvolume configuration information, each piece of data to be backed up to corresponding one of the secondary end controllers; and processing, by the each of the secondary end controllers, respectively received data to be backed up, to complete data backup at a secondary end.

The nonvolatile computer-readable storage medium (or referred to as nonvolatile readable storage medium) may include: various media that can store program codes, such as a USB flash disk, a mobile hard disk, a read-only memory (ROM), a random access memory (RAM), a magnetic disk, or a compact disc.

For the introduction of the nonvolatile computer-readable storage medium (or referred to as nonvolatile readable storage medium) provided by the embodiment of the present application, reference may be made to the above method embodiment, and details are not repeatedly described in the embodiment of the present application.

The embodiments in the present specification are described in a progressive manner. Each embodiment focuses on a difference from other embodiments. For the same or similar parts of the embodiments, reference may be made to each other. With respect to the device, the apparatus and the nonvolatile computer-readable storage medium (or referred to as nonvolatile readable storage medium) disclosed in the embodiments, since they correspond to the method disclosed in the embodiments, the description thereof is relatively simple, and reference can be made to the description in the method part for related parts.

The principle and implementations of the embodiments of the present application are described herein by using optional examples, and the description of the foregoing embodiments is merely intended to help understand the technical solution and core idea of the embodiments of the present application. It shall be pointed out that for those of ordinary skill in the art, without departing from the principle of the embodiments of the present application, various improvements and modifications may also be made to the embodiments of the present application, and all these improvements and modifications also fall within the scope of protection of the claims of the embodiments of the present application.

1. A method of backing up data, comprising:
acquiring load information of each of secondary end controllers, respectively; allocating, according to the load information of each of the secondary end controllers, each of secondary end logical subvolumes obtained by pre-division to corresponding one of the secondary end controllers, to obtain secondary end subvolume configuration information;
synchronizing the secondary end subvolume configuration information to a primary end, to enable the primary end transmit, according to the secondary end subvolume configuration information, each piece of data to be backed up to corresponding one of the secondary end controllers; and
processing, by each of the secondary end controllers, respectively received data to be backed up, to complete data backup at a secondary end.

2. The method according to claim 1, wherein the allocating, according to the load information of each of the secondary end controllers, each of secondary end logical subvolumes obtained by pre-division to corresponding one of the secondary end controllers, to obtain secondary end subvolume configuration information comprises:
allocating, according to the load information of each of the secondary end controllers, each of the secondary end logical subvolumes obtained by pre-division to corresponding one of the secondary end controllers, to obtain an allocation result;
generating, according to the allocation result, IO paths corresponding to each of the secondary end controllers respectively;
acquiring identification information of each of the secondary end controllers, respectively; and
generating the secondary end subvolume configuration information according to each of the IO paths and the identification information of each of the secondary end controllers.

3. The method according to claim 2, before acquiring load information of each of the secondary end controllers, respectively, further comprising:
acquiring a quantity of the secondary end controllers;
performing subvolume division on a secondary volume according to the quantity of the secondary end controllers, to obtain the secondary end logical subvolumes; and
allocating each of the secondary end logical subvolumes to corresponding one of the secondary end controllers to obtain initial subvolume ownership information, and synchronizing the initial subvolume ownership information to the primary end;
the allocating, according to the load information of each of the secondary end controllers, each of the secondary end logical subvolumes obtained by pre-division to corresponding one of the secondary end controllers comprises:
judging, according to the load information of each of the secondary end controllers, whether to adjust the initial subvolume ownership information; and
in a case where it is judged, according to the load information of each of the secondary end controllers, to adjust the initial subvolume ownership information, adjusting the initial subvolume ownership information according to the load information of each of the secondary end controllers.

4. The method according to claim 3, wherein the judging, according to the load information of each of the secondary end controllers, whether to adjust the initial subvolume ownership information comprises:
acquiring, according to the load information of each of the secondary end controllers, a load difference value between a secondary end controller with a maximum current load and a secondary end controller with a minimum current load; and
judging whether the load difference value exceeds a preset threshold.

5. The method according to claim 3, after adjusting the initial subvolume ownership information according to the load information of each of the secondary end controllers, further comprising:
recording first subvolume identification information of an adjusted secondary end logical subvolume, first secondary volume identification information of a secondary volume to which the adjusted secondary end logical subvolume belong, and first secondary end controller identification information of a secondary end controller to which the adjusted secondary end logical subvolume belong; and
generating the secondary end subvolume configuration information according to the first subvolume identification information, the first secondary volume identification information and the first secondary end controller identification information.

6. The method according to claim 3, wherein the performing subvolume division on a secondary volume according to the quantity of the secondary end controllers comprises:
acquiring a preset secondary end logical subvolume size; and
performing subvolume division on the secondary volume according to the secondary end logical subvolume size;
the allocating each of the secondary end logical subvolumes to corresponding one of the secondary end controllers comprises:
sequentially numbering each of the secondary end logical subvolumes starting from 1, to obtain a number of each of the secondary end logical subvolumes;
obtaining a remainder when the number of each of the secondary end logical subvolumes is divided by the quantity of the secondary end controllers, as a remainder result corresponding to the number of each of the secondary end logical subvolumes; and
allocating each of the secondary end logical subvolumes to corresponding one of the secondary end controllers according to the remainder result corresponding to the number of each of the secondary end logical subvolumes.

7. The method according to claim 3, after synchronizing the initial subvolume ownership information to the primary end, further comprising:
receiving a subvolume hotspot data statistical result sent by the primary end; judging, according to the subvolume hotspot data statistical result, whether to adjust the initial subvolume ownership information;
in a case where it is judged, according to the subvolume hotspot data statistical result, to adjust the initial subvolume ownership information, adjusting the initial subvolume ownership information according to the subvolume hotspot data statistical result, to obtain target subvolume ownership information; and
synchronizing the target subvolume ownership information to the primary end.

8. The method according to claim 7, wherein the adjusting the initial subvolume ownership information according to the subvolume hotspot data statistical result comprises:
allocating each of hotspot logical subvolumes to corresponding one of the secondary end controllers in a balanced manner according to the subvolume hotspot data statistical result.

9. The method according to claim 7, wherein the adjusting the initial subvolume ownership information according to the subvolume hotspot data statistical result, further comprising:
recording second subvolume identification information of an adjusted secondary end logical subvolume, second secondary volume identification information of a secondary volume to which the adjusted secondary end logical subvolume belong, and second secondary end controller identification information of a secondary end controller to which the adjusted secondary end logical subvolume belong; and
generating the target subvolume ownership information according to the second subvolume identification information, the second secondary volume identification information and the second secondary end controller identification information.

10. The method according to claim 7, wherein the receiving a subvolume hotspot data statistical result sent by the primary end comprises:
receiving the subvolume hotspot data statistical result sent by the primary end and obtained by performing, according to a data block granularity, hotspot data statistic on each of primary end logical subvolumes.

11. The method according to claim 2, wherein transmitting, by the primary end according to the secondary end subvolume configuration information, each piece of data to be backed up to corresponding one of the secondary end controllers comprises:
transmitting, by the primary end according to the secondary end subvolume configuration information, each piece of the data to be backed up to the corresponding one of the secondary end controllers according to a grain granularity via an IO path corresponding to the corresponding one of the secondary end controllers respectively.

12. The method according to claim 11, wherein the transmitting, by the primary end according to the secondary end subvolume configuration information, each piece of the data to be backed up to the corresponding one of the secondary end controllers according to a grain granularity via an IO path corresponding to the corresponding one of the secondary end controllers respectively comprises:
transmitting, by the primary end according to the secondary end subvolume configuration information, each piece of the data to be backed up to the corresponding one of the secondary end controllers according to the grain granularity by using a service-time strategy via an IO path corresponding to the corresponding one of the secondary end controllers respectively.

13. The method according to claim 1, wherein the secondary end subvolume configuration information comprises a correspondence between each of the secondary end logical subvolumes and each of the secondary end controllers.

14. The method according to claim 6, before acquiring a preset secondary end logical subvolume size, further comprising:
presetting a division granularity for performing subvolume division on a logical volume, wherein the division granularity is configured to represent a size of the secondary end logical subvolume.

15. The method according to claim 1, wherein the processing, by each of the secondary end controllers, respectively received data to be backed up, to complete data backup at a secondary end comprises:
performing, by each of the secondary end controllers, a reading and writing operation on one or more secondary end logical subvolumes corresponding to each of the secondary end controllers, to complete data backup at the secondary end.

16. The method according to claim 9, wherein a three-dimensional data type constructed by the second subvolume identification information, the second secondary volume identification information and the second secondary end controller identification information does not record all logical subvolume information, only records logical subvolume information that needs to be adjusted, and records a node identifier as a group identifier of a group of IO paths, wherein the node identifier is an identifier of a secondary end controller to which an adjusted secondary end logical subvolume of which the logical subvolume information needs to be adjusted belongs, the group of IO paths exist between the primary end and the secondary end controller to which the adjusted secondary end logical subvolume of which the logical subvolume information needs to be adjusted belongs.

17. The method according to claim 16, after generating the target subvolume ownership information according to the second subvolume identification information, the second secondary volume identification information and the second secondary end controller identification information, further comprising:
finding, by the primary end when transmitting the data to be backed up, a secondary end controller identifier as the second secondary end controller identification information in the three-dimensional data type according to a logical volume identifier as the second secondary volume identification information and a logical subvolume identifier as the second subvolume identification information, if the secondary end controller identifier is found, sending the data to a group of IO paths corresponding to a secondary end controller identified by the secondary end controller identifier for transmission, and if the secondary end controller identifier is not found, transmitting the data according to the initial subvolume ownership information.

18. (canceled)

19. An apparatus of backing up data, comprising:
a memory, configured to store a computer program; and
a central processing unit, configured to, when executing the computer program, implement steps of the method of backing up data according to any of claims 1 to 17.

20. A nonvolatile computer-readable storage medium, storing a computer program, wherein when the computer program is executed by a central processing unit, steps of the method of backing up data according to claim 1 are implemented.

21. The method according to claim 4, after synchronizing the initial subvolume ownership information to the primary end, further comprising:
receiving a subvolume hotspot data statistical result sent by the primary end;
judging, according to the subvolume hotspot data statistical result, whether to adjust the initial subvolume ownership information;
in a case where it is judged, according to the subvolume hotspot data statistical result, to adjust the initial subvolume ownership information, adjusting the initial subvolume ownership information according to the subvolume hotspot data statistical result, to obtain target subvolume ownership information; and
synchronizing the target subvolume ownership information to the primary end.
